(19) United States
(12) Patent Application Publication
(10) Pub. No.: US 2024/0078607 A1
(43) Pub. Date: Mar. 7, 2024

(54) DIGITAL SYSTEM FOR CONTROLLED BOOST OF EXPERT FORECASTS IN COMPLEX PREDICTION ENVIRONMENTS AND CORRESPONDING METHOD THEREOF

(71) Applicant: Swiss Reinsurance Company Ltd., Zürich (CH)

(72) Inventors: Maura FEDDERSEN, Zürich (CH); Francesca TAMMA, Zürich (CH); Andrea SCASCIGHINI, Zürich (CH)

(73) Assignee: Swiss Reinsurance Company Ltd., Zürich (CH)

(21) Appl. No.: 18/367,651

(22) Filed: Sep. 13, 2023

Related U.S. Application Data
(63) Continuation of application No. PCT/EP2022/082022, filed on Nov. 15, 2022.

(30) Foreign Application Priority Data
Nov. 15, 2021 (CH) 070553/2021

(51) Int. Cl. G06Q 40/06; G06Q 10/04

(52) U.S. Cl. CPC G06Q 40/06; G06Q 10/04

(57) ABSTRACT

Proposed is a digital system and robust expert method for accuracy-enhanced expert forecasting based on a digital audit-linked best-estimation framework, wherein the audit-based best-estimation framework comprises two or more execution member executing at least the steps of (i) determining a forecasted value for a definable future time window benchmarking the audit-based best-estimation framework to a starting point value based on one or more historical databases, (ii) determining a 90% confidence interval range for the determined starting point value by a lower bund value and an upper bond value of the interval range, wherein the starting point value is part of the confidence interval value range, and wherein an actually measured value of the forecasted value in the future time window is forecasted to measurably deviate with a 90% probability within the 90% confidence interval range, and (iii) selecting one or more possible scenarios each having a definable probability distribution and applying a sensitivity analysis by at least varying a time-based range of an observation window, wherein if the forecasted value deviates further from the starting point value as a predefined threshold value by the variation, the starting point value is adjusted. The forecasted values of the at least two execution member are transmitted and captured by a best-estimation engine determining a best-estimation forecasted value based on the captured forecasted values of the at least two execution member.

### CROSS REFERENCE TO RELATED APPLICATIONS

This application is a continuation of and claims benefit under 35 U.S.C. § 120 International Application No. PCT/EP2022/082022, filed Nov. 15, 2022, which is based upon and claims the benefit of priority from Swiss Application No. 070553/2021, filed Nov. 15, 2021, the entire contents of each of which are incorporated herein by reference.

### FIELD OF THE INVENTION

The present invention relates to a digital system and digital tool for improving accuracy of forecasts and strengthen of the robustness of expert judgment and forecast accuracy based on behavioral and decision science and technology. The digital system comprises (i) technically based training structures (e.g. for new joiners, existing teams, and cross-functional teams), (ii) checklists (e.g. for individuals' guidance or review guidance), (iii) Guided forecasting for small/medium groups (e.g. for the assessment of the impact of legal changes, forecasting of parameters that are relevant for an entire market, etc.), and (iv) large scale forecasting (forecasts that benefit from the viewpoint diversity of a large group).

### BACKGROUND OF THE INVENTION

Expert judgement-driven forecasting and forecasting systems play an important role in various technical fields (e.g. as natural hazard damage forecasting, automated banking, asset management, public policy, or risk-transfer etc.). The following example is discussed from the field of risk-transfer; however, the invention applies to all kinds of expert judgement-driven forecasting and appropriate systems, and risk-transfer serves only as example for an expert judgement-driven forecasting systems. In risk-transfer processes exposures or exposure measures are typically priced through a series of steps. Historical claims costs are derived from summing the costs of insured individuals in the context of their exposure measures. Experts, as actuaries, estimate what the general cost inflation trend will be next period. If a set or portfolio of risk-transfers is large enough to have credible experience (historical costs), the inflation trend may be applied to the historical claims experience to produce an estimate of the expected claims for next period. A profit margin and administrative costs are added to the expected group claims costs to produce the so-called “experience rate”. An underwriter reviews the rate and adjusts the cost and profit margin-based price depending on special circumstances and competitive pressure. The standard practice is to use portfolio-level data for estimating costs and setting prices except for very small portfolios, individual policies, or specific stop loss risk-transfers. Information on the insured's (i.e., individual's) object's conditions is typically not used when portfolio-level data are used for underwriting and pricing the portfolio's aggregate cost forecast.

The current standard practice for estimating future damage costs for portfolios of 50 or more objects uses one of two methods or is a combination of those methods. If the portfolio is large enough to have credible, stable experience, the historical costs are assumed to be the best estimate of next period's costs after a cost trend factor for inflation has been included. If the portfolio is too small to have credible historical costs, many portfolios are combined together and averaged so that a stable statistical look-up table of historical average costs by portfolio characteristics can be developed and used as a weighting mechanism for estimating the expected future costs for non-credible portfolio. Cost trend factors for inflation are then applied. If a portfolio does not have completely credible or non-credible experience, a blended average of its experience and a statistical look-up table forecast is used. These standard actuarial methods do not account for object-level or person-level trends in historical costs nor characteristics data about the object or person.

Thus, there is a need for a robust forecast system relying on a technical and scientific bases allowing to improve and control the forecast accuracy to a level, where, for example, automation and steering signaling of associated automated risk-transfer systems becomes possible. In general, automation and interactive steering of risk-transfer processes are complex and technically extremely challenging, especially, if the risk-exposure is associated with a pool of different objects, individuals, and risks. The reason behind is various, such as the prediction and probability measurements (or expert judgment) of quantifiable risk and risk-exposure, respectively, based on measured physical parameters i.e. related the actual or future occurrence of physical risk or damage events is complex and mainly not parameterizable. Another reason is, for example, the difficulty to measure impact link between the physical objects or individuals and strength and frequency of a predefined physical risk event, as an illness or the occurrence of a natural catastrophic event. Thus, the technical challenges for automated determination, monitoring and steering of forecasted risk-transfer parameters are manifold, where the risk-transfer parameters are defining the portion of the risk which is transferred typically balanced and in exchange of monetary parameter values as part of an underwriting process. Also the generation of quotes for coverage, which relies on the above-mentioned parameters, is technically complex, which is another factors used in quoting and other risk-transfer processes provided to risk-exposed entities is the risk classification of the entity. The risk classification of a risk-exposed entity can be an important factor in determining risk-transfer risk.

As mentioned, risk-transfer processes and underwriting involve the evaluation, measurement, and prediction of risks of risk-exposed units or entities. Underwriting often includes determining a monetary transfer amount (premium) that needs to be charged to tune and balance the amount of risk transferred with the monetary amount. Traditionally, insurance companies typically have their own set of underwriting guidelines to help determine whether or not the company should accept the risk. The information used to evaluate the risk of an applicant for insurance can depend on the type of coverage involved. However, insurance profitability is often based on 30-year-old and older underwriting settings and processes. Moreover, the risk-transfer industry is highly fragmented and utilizes restricted and retrospective data sets, with little connectivity among underwriters, distributors, and the risk-exposed units, they serve. Thus, risk-transfer system seek growth but are technically challenged and limited by high cost ratio's, mismatch of existing risk-transfer products and fragmented, unstructured data.

Known in the prior art are automated or semi-automated risk-transfer systems, typically interacting with a user via graphical user interface (GUI). In particular, automated, cloud-based systems enabling an end-user to compose automatically a first-tier (insurance) and/or second-tier (reinsurance) risk-transfer products, after conducting a dialogue with a knowledge-based system, are known. Such systems reduce the dependences of first-insurers or reinsurers on both their information technology (IT) and their human experts, as e.g. actuarial experts. Such systems are able to adjust the dialogue interactively according to the specific needs of the users and ask for the relevant data needed for the desired risk-transfer product.

Today, automation of the underwriting process is not enough to cope with the challenges mentioned above. The increasingly dynamic and diversified risk-transfer market requires shorter time-to-market of highly customized (re) insurance products. Such processes are technically difficult to automatize. Thus, though the prior art system is able to automate or semi-automate the underwriting process, there is still a need for an electronically controlled system improving and leveraging the forecasted values, in particular in respect to their assumed accuracy for the further use in the risk-transfer process. Further, there is a need for a system provide a technical structure to reduce, monitor and control possible biases introduced by assessments of human expert, where the input of human expert assessments can not yet be completely automated.

In the prior art, the document US 2021/0295447 A1 shows a system for autonomous issuance and management of insurance policies concerning computer technology related risks, such as losses due to system availability, cloud computing failures, current and past data breaches, and data integrity issues. The system uses a variety of current risk information to generate the likelihood of operational interruption or loss due to both accidental issues and malicious activity. Based on the likelihood, the system autonomously issues policies, adjusts premium pricing, processes claims, and seek re-insurance opportunities with a minimum of human input. Further, the prior art document US 2013/0073481 A1 discloses an automated data driven and forward looking risk and reward appetite methodology for consumer and small business. The methodology includes account level historical data collection for customers associated with accounts as part of a portfolio. The account level historical data is automatically segmented into groups of customers with similar revenues and loss characteristics. Segmented data is decomposed into seasoning, vintage, and cycle effects. Statistical clusters are formed based upon the data and effects. A simulation is applied to the statistical clusters and prediction data is generated. A simulation strategy to forecast and simulate revenue and loss volatility is deployed. Efficient frontier curves of risk (e.g., return volatility) and reward (e.g., expected return) are automatically created for the current portfolio under various economic scenarios.

### SUMMARY OF THE INVENTION

It is an object of the invention to provide a technical structure to reduce bias introduced by assessments of human expert. It is a further object to provide a technical system allowing to apply a controlled decision-making architecture technically supporting human experts to become less biased. The expert judgement-driven forecasting should be applicable to all kind of technical forecasting, for example, arising and required in risk-transfer technology, automated banking, asset management, public policy, etc. technical fields. For example, expert judgment processes are at the core of risk-related and/or uncertainty-related disciplines and are sensitive to bias and noise. Therefore, the forecasting system should be able to overcome these deficiencies. It is a further object to provide a system technically allowing to intelligently strengthen the robustness of expert judgment and accuracy. The inventive system shall be able to provide improved accuracy in individual forecast, more robust basis for large-scale decisions, as e.g. risk-transfer decisions, and higher validity of statements from human experts. It is a further object of the present invention to propose a processor-driven system providing an automated digital channel for accuracy-enhanced risk underwriting based on an audit-based best-estimation framework, which does not exhibit the disadvantages of the known systems.

In summary, it can be hold, that where there's expert judgement, there are noise and bias in predictions. It is a fact that the operating expense and cost of noise and bias in uncontrolled expert judgement run into the billions of dollars for any large global industry. This is true for expert judgement-driven forecasting of uncertainty- or risk-exposed objects and/or processes. In the risk-transfer and risk-mitigation industry, the divergence between underwriters' bias of their own assessments of premiums versus actual premiums was measured to be as high as 11%. Id est, there is (i) a measured 11% gap between actually occurring and expected loss ratio, indicating a poor calibration of the prior art risk-transfer systems, (ii) only 1 of 2 monitored estimates are contained in a 90% confidence interval, indicating an significant overconfidence associated with largely uncontrolled technical operation of the prior art risk-transfer systems, and (iii) any arbitrarily selected two underwriters assessing and forecasting the same risk-transfer case by their systems assumed that they would differ by 10%, but on average diverged by measured 56%, indicating a large noise in the forecast and assessment associated with the known prior art system. Therefore, it is an object of the present digital system to allow for a technically controlled operation of the prior art risk-transfer systems and their automation. Finally, it is an object of the present invention to provide a digital system to allow automated traceable, reliable, and reproducible monitoring and boosting of the robustness of expert judgement using behavioral and decision science techniques integrated in an electronic system. The digital system should further allow increasing awareness by automated training and guided session to develop highly accurate forecasts. The inventive digital tool should allow to automize the process and foster consistent measurement.

According to the present invention, these objects are achieved, particularly, with the features of the independent claims. In addition, further advantageous embodiments can be derived from the dependent claims and the related descriptions.

According to the present invention, the above-mentioned objects for a robust digital method for accuracy-enhanced expert forecasting based on an audit-linked best-estimation framework are achieved, particularly, in that the audit-based best-estimation framework comprises two or more execution member executing at least the steps of (i) determining a forecasted value for a definable future time window benchmarking the audit-based best-estimation framework to a starting point value based on one or more historical databases, (ii) determining a 90% confidence interval range for the determined starting point value by a lower bund value and an upper bond value of the interval range, wherein the starting point value is part of the confidence interval value range, and wherein an actually measured value of the forecasted value in the future time window is forecasted to measurably deviate with a 90% probability within the 90% confidence interval range, and (iii) selecting one or more possible scenarios each having a definable probability distribution and applying a sensitivity analysis by at least varying a time-based range of an observation window, wherein if the forecasted value deviates further from the starting point value as a predefined threshold value by the variation, the starting point value is adjusted, and in that the forecasted values of the at least two execution member are transmitted and captured by a best-estimation engine determining a best-estimation forecasted value based on the captured forecasted values of the at least two execution member. Further, according to the present invention, the above-mentioned objects for a robust expert method and system for accuracy-enhanced forecast is related to forecasted base rates for risk underwriting based on an audit-based best-estimation framework are achieved, particularly, in that the audit-based best-estimation framework comprises two or more execution member executing at least the steps of (i) determining a base rate value benchmarking the audit-based best-estimation framework to a starting point value based on one or more historical databases, (ii) determining a 90% confidence interval range for an estimated return period, and (iii) selecting one or more possible scenarios each having a corresponding probability distribution and applying a sensitivity analysis at least by varying a time-based range of an observation window, wherein if the value of the base rate deviates further from the starting point value as a predefined threshold range by the variation, the starting point value of the base rate is adjusted, and in that a best-estimation base rate value is determined on the forecasted base rate of each execution member. The inventive system has, inter alia, the advantage that it provides digital tool that allows guiding individuals and groups to develop highly accurate expert judgement leveraging best practices from behavioural and decision science. This system allows to foster consistent measurement and calibration of forecasting performance, including accuracy (where possible) and KPIs providing technical measures of the robustness of the digital guided, monitored, and controlled process. The inventive system can e.g. be realized as a digital share point tool which allows to scale the solution to large groups of individual expert systems and experts.

Furthermore, calibration involves sharing back dynamically determined, highly personalized feedback (e.g. realized as operational step 7 (steps 1-6 see above)) to users of ‘noise’ and ‘bias’ as well as automated generated actions to take to improve their future forecasting performance, reflecting their individual patterns of behavior and relevant corrective actions. The term noise, as used above, reflects and denotes unwanted variance in estimations from the target, and bias reflects systematic deviations from the target. In contrast to prior art systems, the automated feedback provided by inventive system arises from using and applying data science techniques (incl. machine learning/artificial intelligence) and relies on additional measuring data points of aptitudes/traits, training outcomes and performance measures in other forecasting areas. In this way, the inventive system technically newly allow to establish a forecasting aptitude and performance measure and rating that fosters learning and development among users, as well as gives constructive input into career development processes (e.g. progression discussions). Assessing forecasting performance establishes a proven track record of some outperforming in forecasting, across the board or in particular subject matter areas. This allows for the automated selection of experts for key forecasting cases based on historic performance and generates more accurate forecasts for business decisions.

A build-in review process provides managers with sign off rights to add their perspectives and sign off on the estimations derived in the overall process. This allows to analyse and disentangle forecasting accuracy due to the process and due to management input, with potential implications including updating processes to focus on proven sources of accuracy. The inventive digital system integrates to ingest data from relevant analytical data modeling structures and to feed forecasting information into operational or business modelling, with an auditable journey from ingestion of data through to delivery of data in operation or business modelling. This integration and tracking allows data-drive recognition to assess which factors correlate with forecasting accuracy. The inventive system has further the advantage to provide flexibility for users in selection of methodological configuration, including step selection, informed by a variety of factors that characterize the forecasting case (e.g. degree of volatility, uncertainty, complexity, ambiguity) and operating context (business criticality, time pressure, degree of resources, experts on hand). The inventive system provides a methodological configuration reflecting whether to forecast and/or estimate one or more parameters (number of parameters), alone or with other participants (number of participants), to estimate a point estimate, range, or probability distribution (type of output required) as part of the elicitation process.

Further, the inventive system allows to provide step selection and potentially repetition: this can e.g. involve more robust processes that involve all steps, even repeating steps, or it may involve lean configurations that focus on, for example, steps 1-5 only. A global knowledge data store of connected forecasting cases can e.g. generate information for users of relevant data sources, causal drivers, and models among others, to consider in forecasting cases in development. As a further embodiment variant, the definition of step 2, rather than defining the 90% range at the outset, users is requested to estimate it themselves. This step comprises asking people to do the following: 1) set the realistic lower bound, 2) set the realistic upper bound, 3) estimate the confidence that the range of 1) ñ 2) contains the correct answer, thereafter 4) revise your forecast.

As an embodiment variant, said 90% confidence interval range for the estimated return period is determined based on market rate and/or industry or market loss ratio and/or benchmark values of similar transactions or risk-transfer systems of underwriting setups.

In another embodiment variant, said 90% confidence interval range for the estimated return period is determined by setting an upper and lower bound value equal-distant or not-equal-distant to the starting point value of the base rate value.

In an embodiment variant, said sensitivity analysis is applied by at least varying a time-based range of an observation window and/or a return period of losses and/or a distribution for fitting and/or different methods for extrapolation.

In a further embodiment variant, said sensitivity analysis is applied by further comparing a deviation of a forecasted total rate change over an observation window of 3 years to a forecasted yearly rate change and/or by comparing the forecasted value by aggregated or separately considered different regions and/or comparing the forecasted value by aggregated or separately considered line of businesses.

In an even further embodiment variant, the different base rate values are determined by varying the one or more historical databases for detecting possible biases introduced by specific compositions of the one or more historical databases.

Finally, in an embodiment variant, the two or more execution members comprise execution members with different role comprising client managers and/or claims experts and/or reserving actuaries and/or casualty R&D members and/or casualty center members and/or faculty underwriting members.

### BRIEF DESCRIPTION OF THE DRAWINGS

The present invention will be explained in more detail, by way of example, with reference to the drawings in which:

FIG. 1 shows a block diagram schematically illustrating a number of exemplary identified factors, including cognitive biases, that influence expert judgement and forecasting performance, which are considered by the digital system, platform, and digital method for controlled boost of expert forecasts and/or forecast results in complex prediction environments. The inventive digital system provides electronic guidance and electronic control to individuals and groups, enabling the individuals and groups by using the inventive system and digital guidance to develop highly accurate expert judgement leveraging best practices from behavioural and decision science. By boosting the robustness of expert judgement being based on behavioural and decision science, the inventive digital system or tool allows to automize the process and foster consistent measurement.

FIG. 2 shows a block diagram schematically illustrating an exemplary embodiment variant of the inventive digital and electronically based methodology with scientifically validated technical method steps 0 to 7, the inventive digital system, and the achieved improvements.

FIGS. 3a and 3b show diagrams schematically illustrating an exemplary embodiment variant of a guided input part of a digital channel of the inventive digital system for controlled enhancement of expert judgements in predictions. The input part of the digital channel can e.g. be realized as a graphical user interface (GUI) connecting different individual expert systems or individual experts to a central data processing engine.

FIGS. 4a to 4h show block diagrams schematically illustrating an exemplary embodiment variant of the inventive digital and electronically based methodology with scientifically validated technical method steps 0 to 7 of FIG. 2 in detail. The method comprises as step 0 (FIG. 4a) the capturing of initial forecasts, step 1 (FIG. 4b) the determination of the base rate as benchmark, as step 2 (FIG. 4c) the determination of the confidence intervals of 90% by setting a upper and lower bound around the forecasted result, as step 3 (FIG. 4d) the determination of the sensitivities of the forecasted result, as step 4 (FIG. 4e) detecting by source diagnostics possible source bias, as step 5 (FIG. 4f) self-calibration using analyses using standardized and comparable output responses, as step 6 (FIG. 4g) best estimation mapping by aggregating group forecast results and leveraging and increasing individual accuracy to group accuracy, and as step 7 (FIG. 4h) the closing of the inventive feedback loop.

FIGS. 5 to 7 shows block diagram schematically illustrating an exemplary embodiment variant of the inventive digital system for controlled improvement of expert forecasts in complex prediction environments.

### DETAILED DESCRIPTION OF THE PREFERRED EMBODIMENTS

The inventive digital system 1 and digital platform 200 provides a technical structure for controlled and measured improvement and enhancing of accuracy measurands of forecasts and/or forecast results and strengthen of the robustness and expert forecast accuracy, in particular risk-related underwriting forecasts as base rate values, reducing cognitive bias of expert judgment based on behavioral and decision science. The digital system can be realized comprising (i) an electronic guidance and/or training unit (e.g. for new joiners, existing teams, and cross-functional teams), (ii) a checklist unit (e.g. for individuals' guidance or review guidance), (iii) a guided forecasting unit for small/medium groups (e.g. for the assessment of the impact of legal changes, forecasting of parameters that are relevant for an entire market, etc.), and (iv) a large scale forecasting units providing forecasts that benefit from the viewpoint diversity of a large group. The digital system and modular platform can e.g. comprise a step 0 to automatically request and capture the individual expert's initial forecast and/or forecast values by the digital system 1, a step 1 concerning the setting and/or determination of a credible benchmark value and/or forecast value starting point e.g. for bases rate values, a step 2 to technically tackle overconfidence impacts by assessing and/or setting confidence levels and intervals in the forecasting process, a step 3 assessing and/or considering sensitivity and scope of outcome under different technical angles, a step 4 concerning diagnostics to avoid over- and underreaction to information, a step 5 concerning self-calibration related to forecast, measure, and revise, a step 6 concerning appropriate comparison, and step 7 enhancing forecast accuracy by providing a digital feedback loop, allowing experts to learn and improve from experience. As proved by studies, the inventive digital method and system 1 has the measurable advantages to provide 5-40% accuracy gains in the prediction of key parameters, to provide scalability of the number of experts trained and through digital tools, and to provide technical reliability, reproducibility and traceability by iteratively enhance the measured accuracy of the experts' forecasts and/or forecast values.

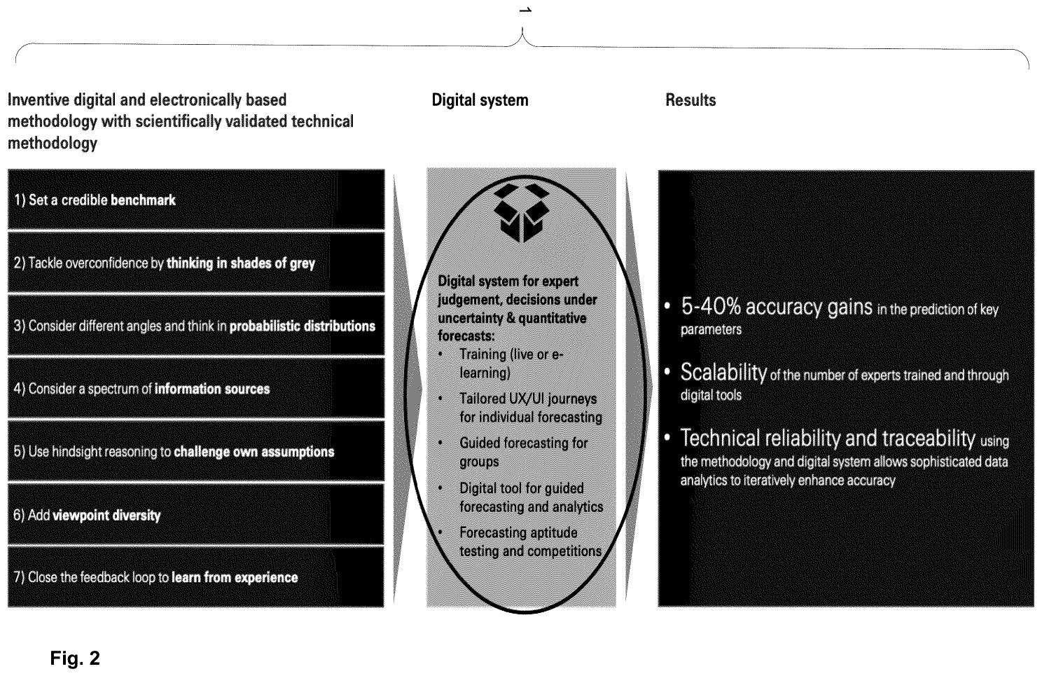

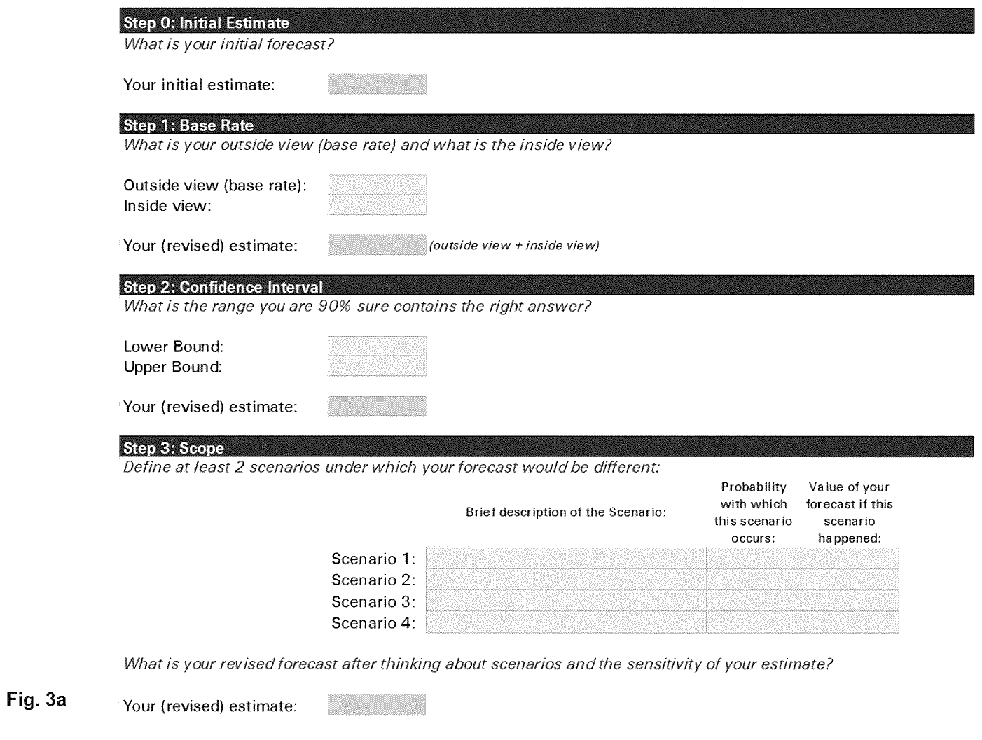

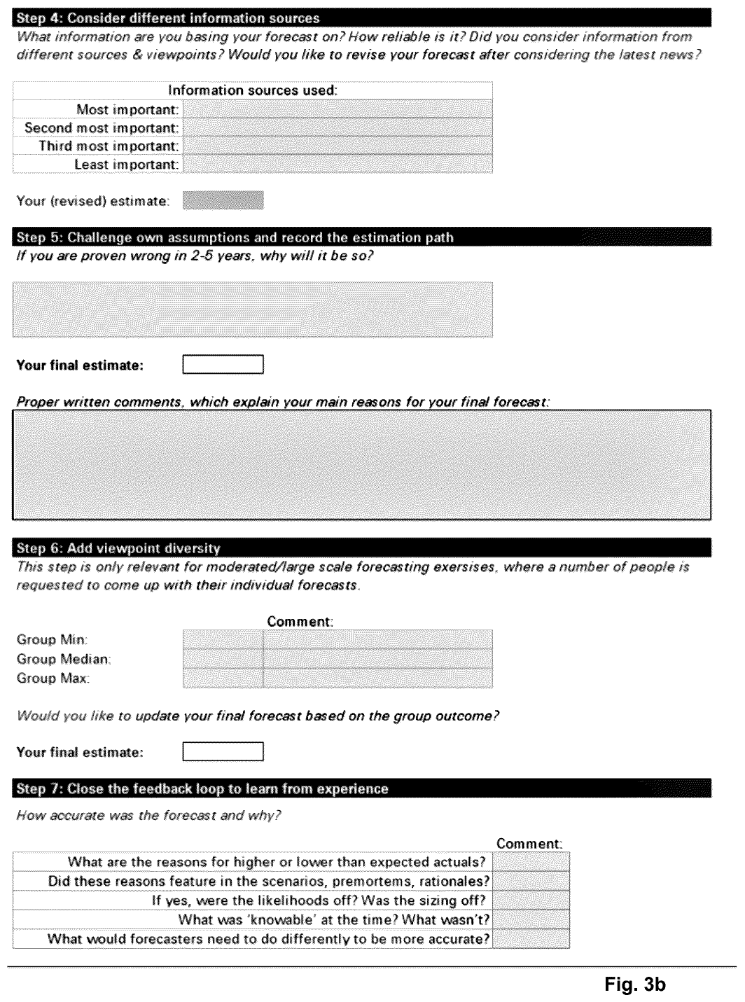

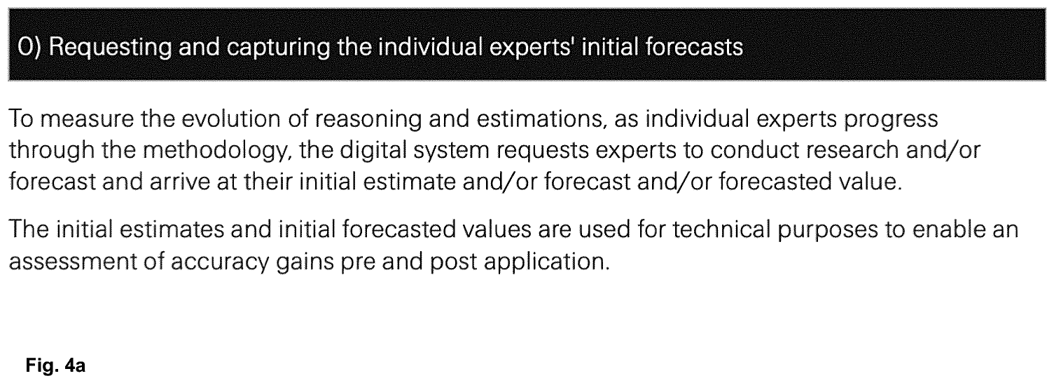

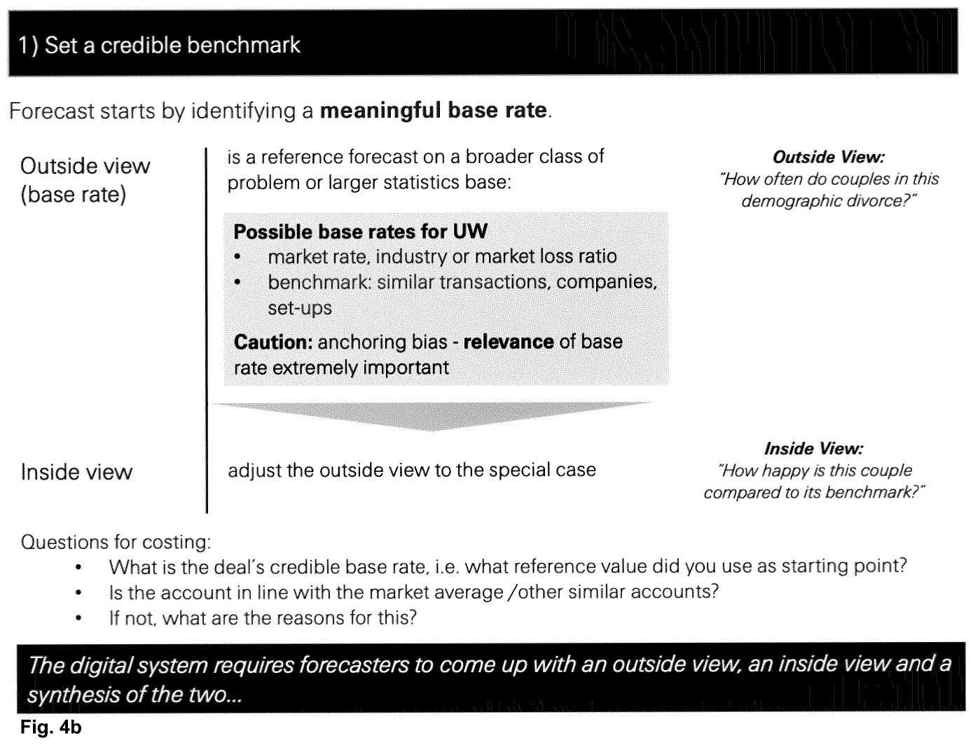

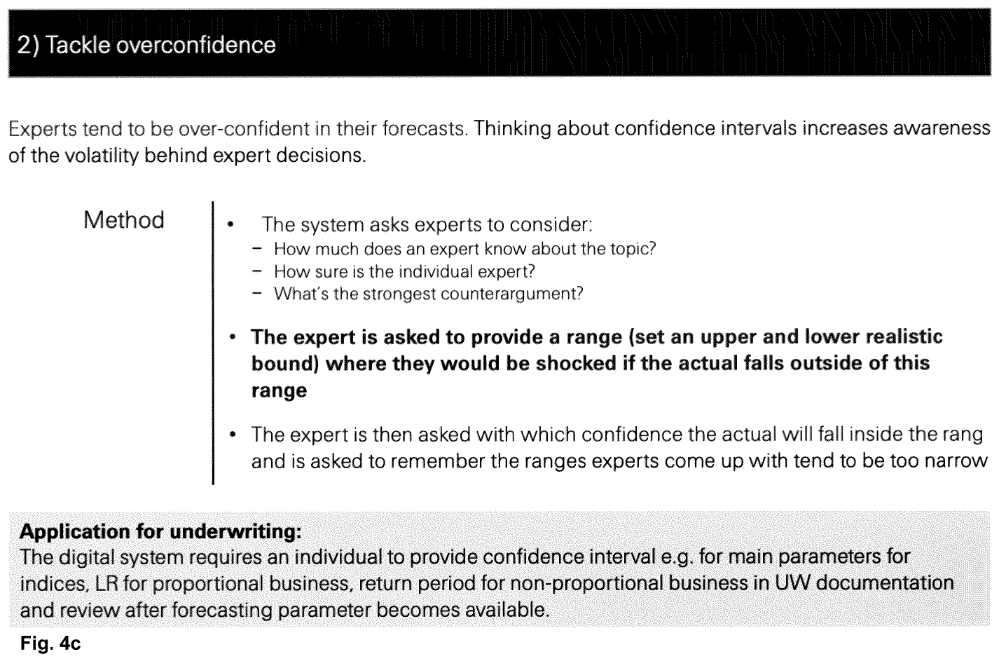

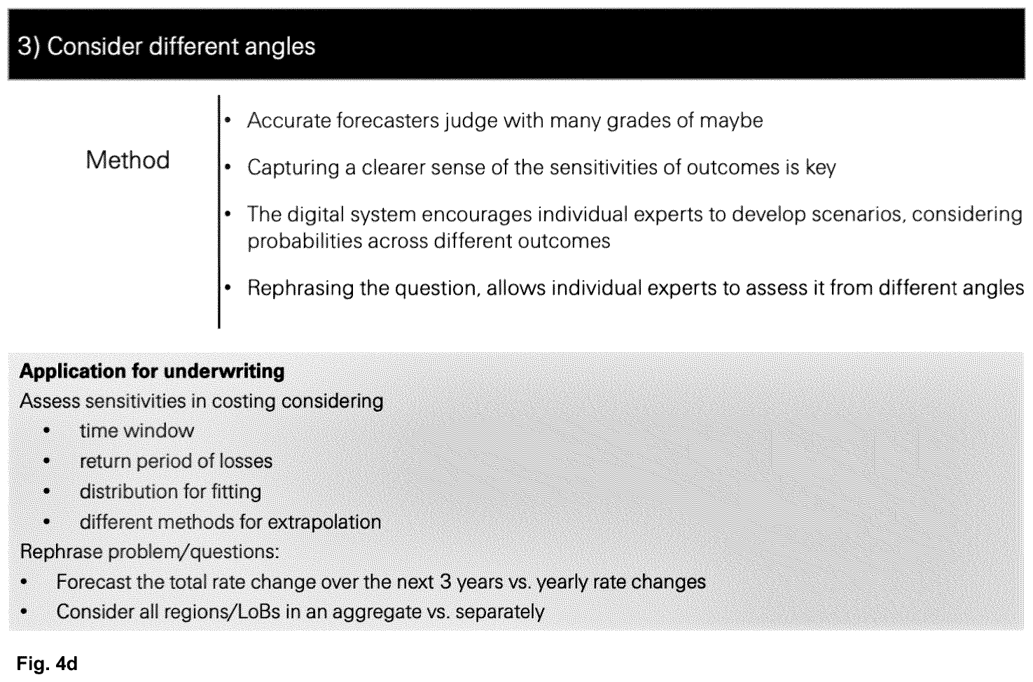

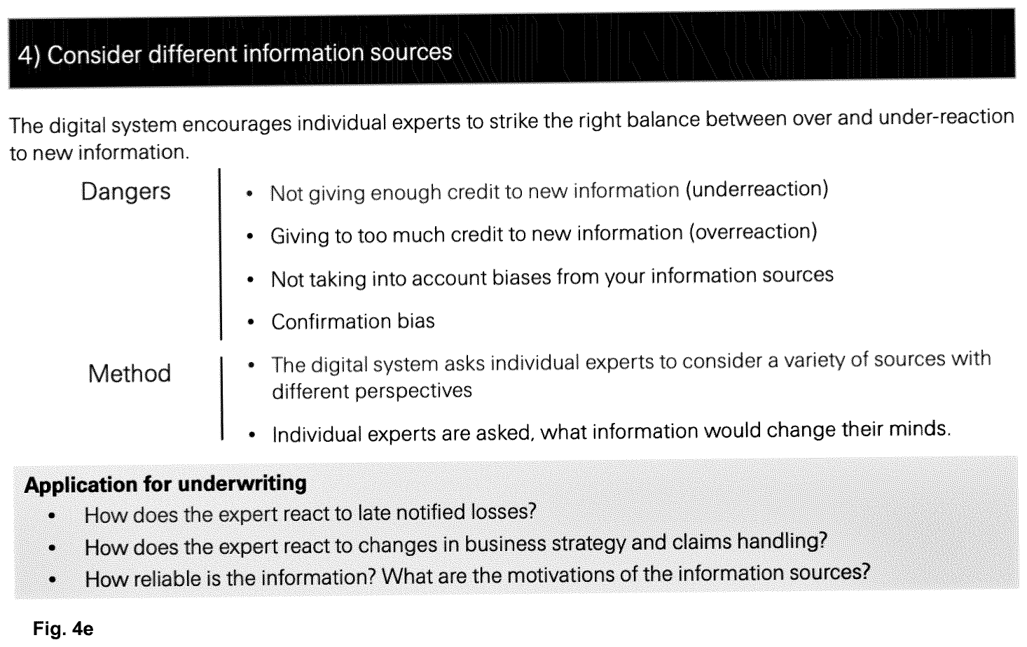

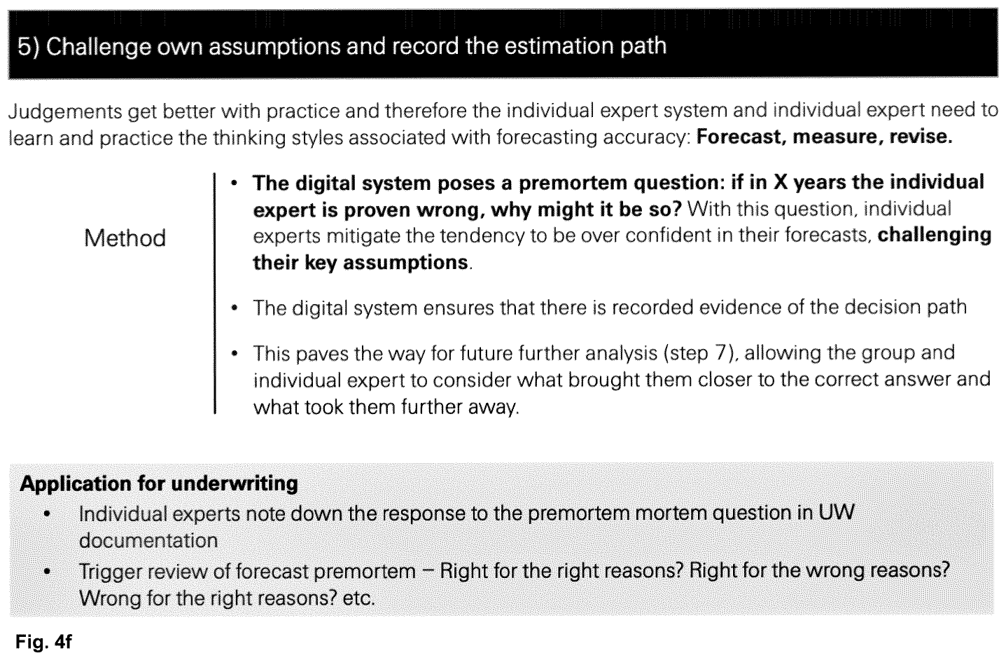

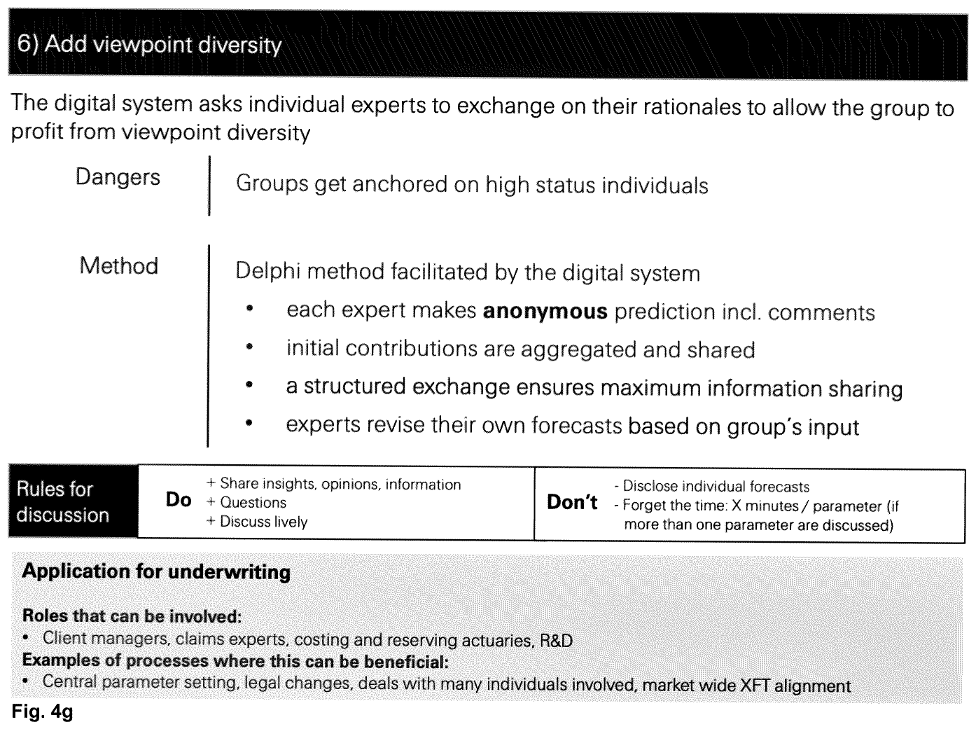

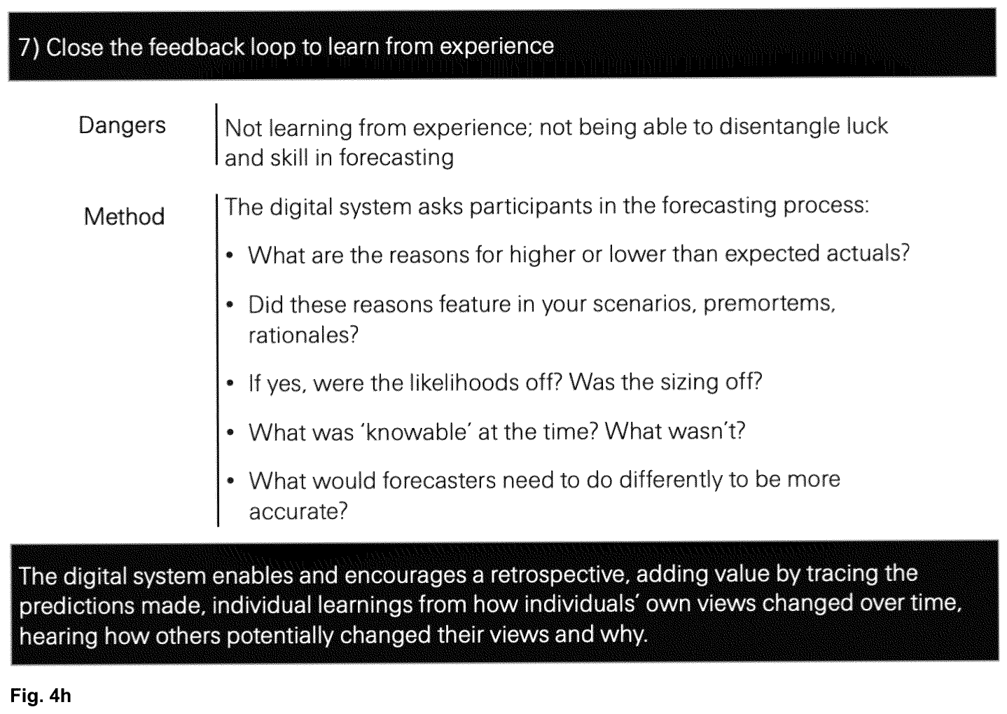

FIG. 2 and FIGS. 4a-4h schematically illustrate an architecture for a possible implementation of an embodiment of the inventive system and method further comprising an end-to-end digital channel for automated the inventive process of improving the process of expert forecast results in complex prediction environments. Exemplarily, complex underwriting processes are discussed herein, relating on expert forecast results for risks, i.e. future occurrence frequencies and strength of impacting events causing a damage or loss at a risk-exposed object and/or individual. Such complex prediction environments are often not parametrizable by known prior art processes, and highly non-linear in behavior (in respect to occurrence frequency and/or strength).

The inventive robust digital system and method for accuracy-enhanced expert forecasting based on an audit-linked, digital best-estimation framework comprises two or more execution member executing at least the steps of
(1) determining a forecasted value for a definable future time window benchmarking the audit-based best-estimation framework to a starting point value based on one or more historical databases,
(2) determining a 90% confidence interval range for the determined starting point value by a lower bund value and an upper bond value of the interval range, wherein the starting point value is part of the confidence interval value range, and wherein an actually measured value of the forecasted value in the future time window is forecasted to measurably deviate with a 90% probability within the 90% confidence interval range, and
(3) selecting one or more possible scenarios each having a definable probability distribution and applying a sensitivity analysis by at least varying a time-based range of an observation window, wherein if the forecasted value deviates further from the starting point value as a predefined threshold value by the variation, the starting point value is adjusted.

The forecasted values of the at least two execution member are transmitted and captured by a best-estimation engine determining a best-estimation forecasted value based on the captured forecasted values of the at least two execution member.

In an embodiment variant, the digital platform provids accuracy-enhanced risk underwriting based on the audit-based best-estimation framework. The digital platform provides a digital channel for automated audit-based best-estimation forecast of base rate values for underwriting in complex contextual environments covering heterogenous risk sources and risk-exposure classes, wherein the digital channel being provided two or more execution member assessing the digital platform by means of network-enabled devices via a data transmission network and executing at least the steps of
(i) determining a base rate value benchmarking the audit-based best-estimation framework to a starting point value based on one or more historical databases,
(ii) determining a 90% confidence interval range for an estimated return period, and
(iii) selecting one or more possible scenarios each having a corresponding probability distribution and applying a sensitivity analysis at least by varying a time-based range of an observation window, wherein if the value of the base rate deviates further from the starting point value as a predefined threshold range by the variation, the starting point value of the base rate is adjusted, and

A best-estimation base rate value is determined based on the forecasted base rates of all execution member. Said 90% confidence interval range can e.g. be determined for the estimated return period based on a market rate and/or an industry rate and/or a market loss ratio value and/or benchmark values of similar transactions or risk-triggered systems. Said 90% confidence interval range for the estimated return period can e.g. be determined by setting an upper and lower bound value equal-distant or not-equal-distant to the starting point value of the forecasted value. Said sensitivity analysis can e.g. be applied at least by varying a time-based range of an observation window and/or a return period of losses and/or a distribution for fitting and/or different methods for extrapolation. Said sensitivity analysis can e.g. additionally be applied by comparing a deviation of the forecasted value over an observation window of 3 years to a yearly forecasted value and/or by comparing the forecasted values by aggregated or separately considered different regions and/or comparing the forecasted values by aggregated or separately considered line of businesses. Different forecasted values can e.g. be determined by varying the one or more historical databases for detecting possible biases introduced by specific compositions of the one or more historical databases. The two or more execution members comprise execution members with different role can e.g. comprise client managers and/or claims experts and/or reserving actuaries and/or casualty R&D members and/or casualty center members and/or faculty underwriting members.

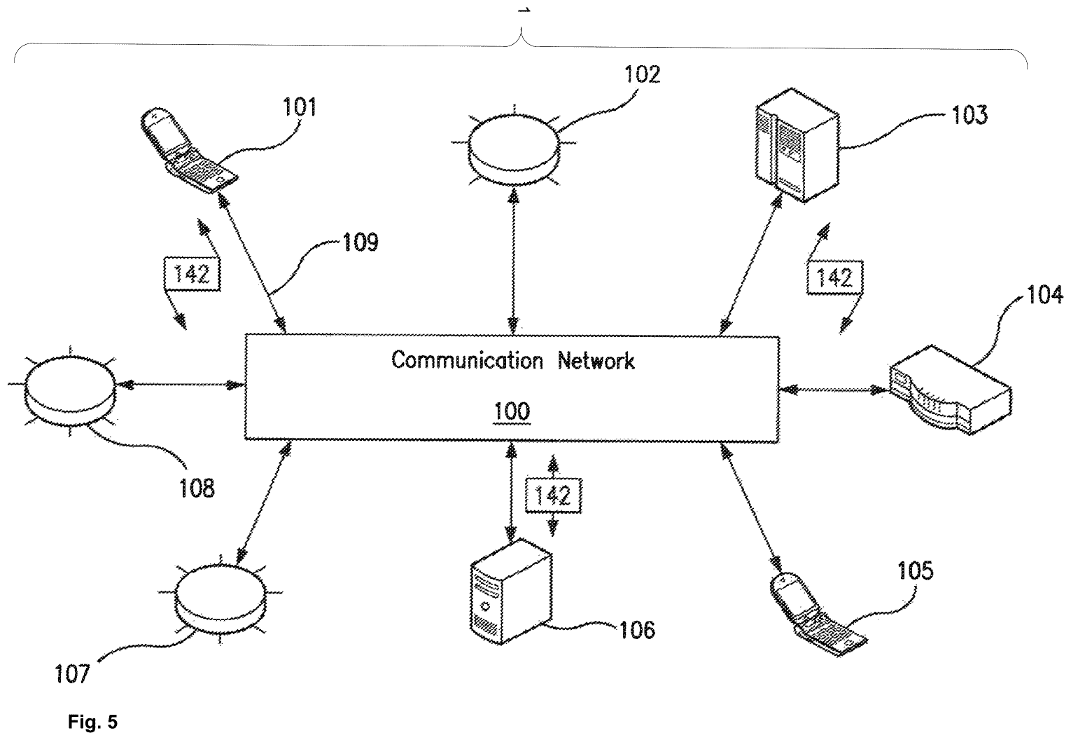

FIGS. 5 to 7 are schematic block diagrams of an exemplary digital system 1 for controlled boost of expert forecasts in complex prediction environments with an exemplary communication network 100 experts' client network devices (to request the expert forecast values and electronically guide the expert through the digital enhancement process) and the sensors 102 to provide a feedback loop with a sensory link to the physical world. The digital system 1 can e.g. comprise nodes/devices 101-108 (e.g., sensors 102, core data processing engine 103, smart phone devices 105, servers 106, routers 107, switches 108, the digital platform 300 and the like) interconnected by various methods of communication. For instance, the links 109 may be wired links or may comprise a wireless communication medium, where certain nodes are in communication with other nodes, e.g., based on distance, signal, forecasted event or exposure type and/or strength, current operational status, location, etc. Moreover, each of the devices can communicate data packets (or frames) 142 with other devices using predefined network communication protocols as will be appreciated by those skilled in the art, such as various wired protocols and wireless protocols etc., where appropriate. In this context, a protocol consists of a set of rules defining how the nodes interact with each other. Those skilled in the art will understand that any number of nodes, devices, links, etc. may be used in the computer network, and that the view shown herein is for simplicity. Also, while the embodiments are shown herein with reference to a general network cloud, the description herein is not so limited, and may be applied to networks that are hardwired.

As will be appreciated by one skilled in the art, aspects of the present invention may be embodied as a system, method or computer program product. Accordingly, aspects of the present invention may take the form of an entirely hardware embodiment, an entirely software embodiment (including firmware, client software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized for the digital system 1. The computer readable medium may be a computer readable signal medium or a computer readable storage medium. A computer readable storage medium may be, for example, but not limited to, an elec-tronic, magnetic, optical, electromagnetic, infrared, or semi-conductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propa-gated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the users computer and partly on a remote computer or entirely on the remote computer or server. In the latter scenario, the remote computer may be connected to the users computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block dia-gram block or blocks.

These computer program instructions may also be stored in a computer readable medium that can direct a computer, other programmable data processing apparatus, or other devices to function in a particular manner, such that the instructions stored in the computer readable medium pro-duce an article of manufacture including instructions which implement the function/act specified in the flowchart and/or 60 block diagram block or blocks. The computer program instructions may also be loaded onto a computer, other programmable data processing appa-ratus, or other devices to cause a series of operational steps to be performed on the computer, other programmable apparatus or other devices to produce a computer imple-mented process such that the instructions which execute on the computer or other programmable apparatus provide processes for implementing the functions/acts specified in the flowchart and/or block diagram block or blocks.

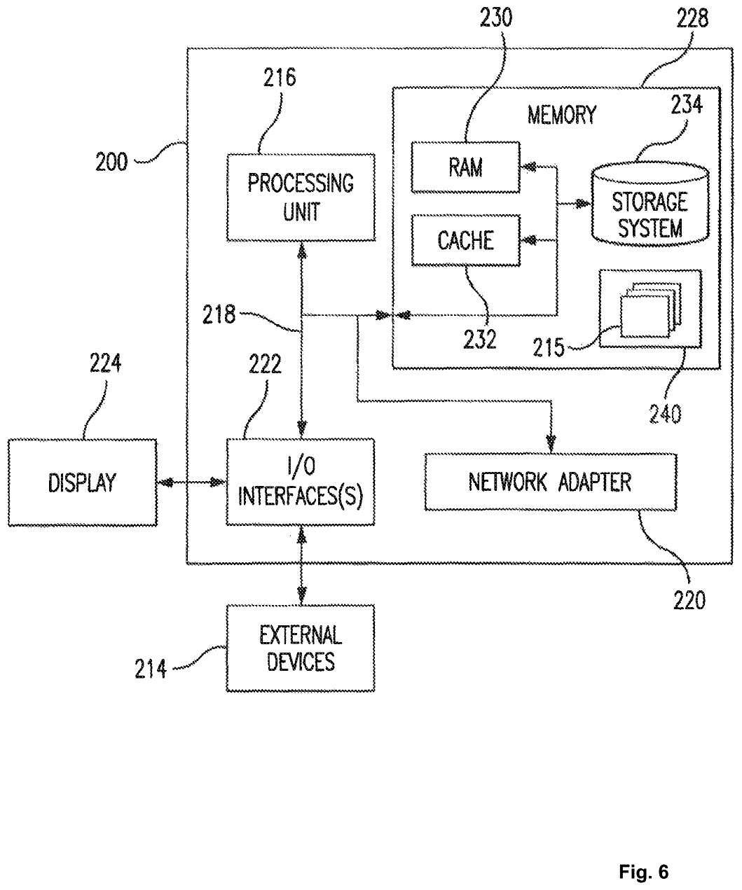

FIG. 6 is a schematic block diagram of an example network computing device 200 (e.g., one of network devices 101-108, or the digital platform 300 with core data processing engine 103) that may be used (or components thereof) with one or more embodiments described herein, e.g., as one of the nodes shown in the network 100. As explained above, in different embodiments these various devices be configured to communicate with each other in any suitable way, such as, for example, via communication network 100. Device 200 is only one example of a suitable system and is not intended to suggest any limitation as to the scope of use or functionality of embodiments of the invention described herein. Regardless, computing device 200 is capable of being implemented and/or performing any of the functionality set forth herein. Computing device 200 is operational with numerous other general purpose or special purpose computing system environments or configurations. Examples of known computing systems, environments, and/or configurations that may be suitable for use with computing device 200 include, but are not limited to, personal computer systems, server computer systems, thin clients, thick clients, hand-held or laptop devices, multiprocessor systems, microprocessor-based systems, set top boxes, programmable consumer elec-tronics, network PCs, minicomputer systems, mainframe computer systems, and distributed data processing environ-ments that include any of the above systems or devices, and the like.

The experts can e.g. access the digital system 1, in particular the digital platform 300 of the data transmission network 100 by network devices 200. Computing device 200 may be described in the general context of computer system-executable instructions, such as program modules, being executed by a computer system. Generally, program modules may include routines, programs, objects, components, logic, data structures, and so on that perform particular tasks or implement particular abstract data types. Computing device 200 may be practiced in distributed data processing environments where tasks are performed by remote processing devices that are linked through a communications network. In a distributed data processing environment, program modules may be located in both local and remote computer system storage media including memory storage devices.

Device 200 is shown in FIG. 6 in the form of a general-purpose computing device. The components of device 200 may include, but are not limited to, one or more processors or processing units 216, a system memory 228, and a bus 218 that couples various system components including system memory 228 to processor 216. Bus 218 represents one or more of any of several types of bus structures, including a memory bus or memory controller, a peripheral bus, an accelerated graphics port, and a processor or local bus using any of a variety of bus archi-tectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus. Computing device 200 typically includes a variety of computer system readable media. Such media may be any available media that is accessible by device 200, and it includes both volatile and non-volatile media, removable and non-removable media. System memory 228 can include computer system read-able media in the form of volatile memory, such as random access memory (RAM) 230 and/or cache memory 232.

Computing device 200 may further include other removable/non-removable, volatile/non-volatile computer system storage media. By way of example only, storage system 234 can be provided for reading from and writing to a non-remov-able, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 218 by one or more data media interfaces. As will be further depicted and described below, memory 228 may include at least one program product having a set (e.g., at least one) of program modules that are configured to carry out the functions of embodiments of the invention.

The data processing unit 240, having a set (at least one) of program modules 215, such as benchmark analyzer module 306 and confidence interval analyzer module 308 described below, may be stored in memory 228 by way of example, and not limitation, as well as an operating system, one or more application programs, other program modules, and program data. Each of the operating system, one or more application programs, other program modules, and program data or some combination thereof, may include an implementation of a networking environment. Program modules 215 generally carry out the functions and/or methodologies of embodiments of the invention as described herein.

Device 200 may also communicate with one or more external devices 214 such as a keyboard, a pointing device, a display 224, etc.; one or more devices that enable a user to interact with computing device 200; and/or any devices (e.g., network card, modem, etc.) that enable computing device 200 to communicate with one or more other computing devices. Such communication can occur via Input/Output (I/O) interfaces 222. Still yet, device 200 can com-municate with one or more networks such as a local area network (LAN), a general wide area network (WAN), and/or a public network (e.g., the Internet) via network adapter 220. As depicted, network adapter 220 communicates with the other components of computing device 200 via bus 218. It should be understood that although not shown, other hard-ware and/or software components could be used in conjunc-tion with device 200. Examples, include, but are not limited to: microcode, device drivers, redundant processing units, external disk drive arrays, RAID systems, tape drives, and data archival storage systems, etc.

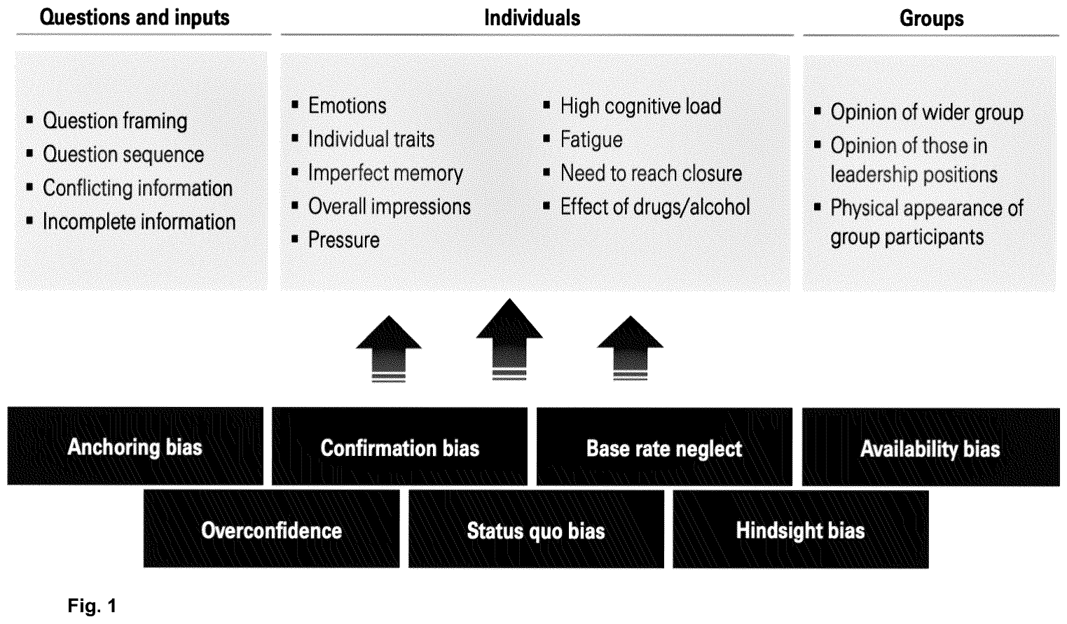

FIGS. 1 and 2 are intended to provide a brief, general description of an illustrative and/or suitable exemplary environment in which embodiments of the below described present invention may be implemented. FIGS. 1 and 2 are exemplary of a suitable environment and are not intended to suggest any limitation as to the structure, scope of use, or functionality of an embodiment of the present invention. A particular environment should not be interpreted as having any dependency or requirement relating to any one or combination of components illustrated in an exemplary operating environment. For example, in certain instances, one or more elements of an environment may be deemed not necessary and omitted. In other instances, one or more other elements may be deemed necessary and added.

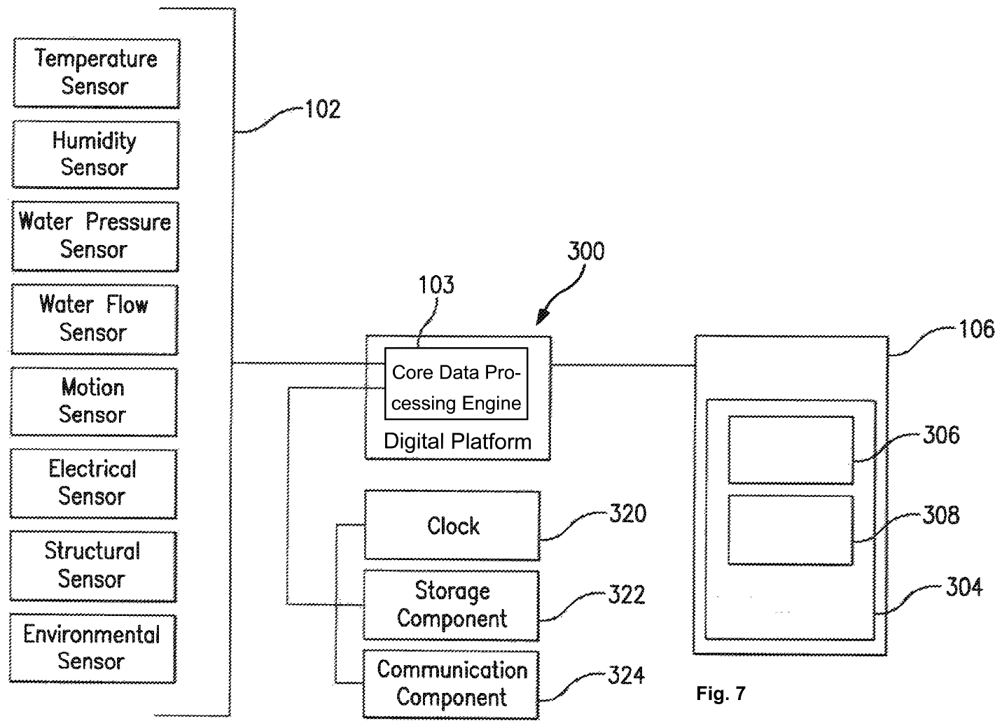

With the exemplary digital system 1 with communication network 100 (FIG. 5) and the more detailed illustration of a computing device 200 (FIG. 6) being generally shown and discussed above, description of certain illustrated embodiments of the present invention will now be provided. With reference now to FIG. 7, an example of a digital platform 300 is shown in which the capture, data processing and analysis of sensor data 102 and expert data is useful for the reasons at least described below. The digital platform 300 preferably includes a core data processing engine 103 for capturing data from a plurality of sensors 102 and experts' client devices 200 which capture data regarding various aspects of digital platform 300 and digital method. It is to be understood core data processing engine 103 may be located in any location, and its position is not limited to the example shown. The core data processing engine 103 is preferably configured and operational to receive (capture) data from various sensors 102 and experts' client systems 200 regarding certain aspects (including functional and operational) of the digital platform 300 and transmit that captured data to a server system 106, via network 100. It is noted device 103 may perform data processing and analytics regarding the captured sensor data regarding forecasted values of the experts and/or the server system 106. It is also to be understood in other embodiments, data from sensors 102 and expert forecasts and forecast values can e.g. be transmitted directly to server system 106, via network 100, thus either obviating the need for ably located or controlled by a carrier, core data processing engine 103 or mitigating its functionality to capture all data from sensors 102 and experts' client devices.

In the illustrated embodiment of FIG. 7, core data processing engine 103 is shown coupled to various below described sensor types 102. Although various sensor types 102 are described shown herein are not intended to be exhaustive as embodiments of the present invention may encompass any type of known or unknown sensor type which facilitates the purposes and objectives of the certain illustrated embodiments described herein. It is to be understood and appreciated, in accordance with the embodiments herein, sensors 102 are preferably installed, and its data is collected, maintained, accessed and otherwise utilized pursuant to the permission of the insured(s) subject to appropriate security and privacy concerns. Exemplary sensor types include (but are not limited to): Temperature sensor, humidity sensor, water sensor(s)/water pressure sensor(s), water flow sensor, leak detection sensor, wind speed sensor, motion sensor, electrical system sensor/analyzer, positional sensor as GPS sensors, structural sensor to detect various structural conditions e.g. of constructions as buildings, environmental sensor, smoke detectors, optical sensors as e.g. satellite or drone imagery, seismic and vibration sensors etc. The sensors 102 are connected to the digital platform 300 in particular to measure the actual accuracy of the various forecasts. Thus, the system 1 has a digital loop-back process to monitor and verify via the sensory link to the real physical world the accuracy of the different forecasts. This step also provides an automated self-calibration process for the digital system 1. Furthermore, it allows to measure by the sensory real-world link the actual enhancement by appropriate physical measuring based measurands.

1. A digital system providing an accuracy-enhanced audit-based best-estimation framework by applying a controlled decision-making architecture technically supporting human experts to become less biased, the digital system comprising:
a digital platform that provides a digital channel for automated audit-based best-estimation forecast of base rate values for underwriting in complex contextual environments covering heterogenous risk sources and risk-exposure classes, wherein the digital channel being provided with two or more execution members assessing the digital platform using network-enabled devices via a data transmission network, wherein the digital platform at least comprises processing circuitry configured to capture data from a plurality of sensors and the network-enabled devices, the two or more execution member executing by using the network-enabled devices at least the steps of
(i) determining a base rate value benchmarking the audit-based best-estimation framework to a starting point value based on one or more historical databases,
(ii) determining a 90% confidence interval range for an estimated return period, and
(iii) selecting one or more possible scenarios each having a corresponding probability distribution and applying a sensitivity analysis at least by varying a time-based range of an observation window, wherein if the value of the base rate deviates further from the starting point value as a predefined threshold range by the variation, the starting point value of the base rate is adjusted, and
in that a best-estimation base rate value is determined on the forecasted base rate of each execution member, and
wherein the plurality of sensors are coupled to the processing circuitry which measures the accuracy the forecasted base rates and provides a digital loop-back process by monitoring and verifying the different forecasted base rates via a sensory link of the plurality of sensors to the real physical world.

2. A digital method for accuracy-enhanced expert forecasting based on an audit-linked, digital best-estimation framework by applying a controlled decision-making architecture technically supporting human experts to become less biased, wherein a digital platform provides a digital channel for automated audit-based best-estimation forecast of base rate values for underwriting in complex contextual environments covering heterogenous risk sources and risk-exposure classes, wherein the digital channel being provided with two or more execution members assessing the digital platform using network-enabled devices via a data transmission network, wherein the digital platform at least comprises processing circuitry configured to capture data from a plurality of sensors and the network-enabled devices, the digital method comprising:
executing, by the two or more execution members using the-network-enabled devices at least the steps of:
(i) determining a forecasted value for a definable future time window benchmarking the audit-based, digital best-estimation framework to a starting point value based on one or more historical databases,
(ii) determining a 90% confidence interval range for the determined starting point value by a lower bund value and an upper bond value of the interval range, wherein the starting point value is part of the confidence interval value range, and wherein an actually measured value of the forecasted value in the future time window is forecasted to measurably deviate with a 90% probability within the 90% confidence interval range, and
(iii) selecting one or more possible scenarios each having a definable probability distribution and applying a sensitivity analysis by at least varying a time-based range of an observation window, wherein if the forecasted value deviates further from the starting point value as a predefined threshold value by the variation, the starting point value is adjusted,
in that the forecasted values of the at least two execution member are transmitted and captured by a best-estimation engine determining a best-estimation forecasted value based on the captured forecasted values of the at least two execution member, and
in that the plurality of sensors is coupled to the data processing engine and connected to the digital platform, wherein the accuracy the forecasted base rates is measured by the plurality of sensors providing a digital loop-back process by monitoring and verifying the different forecasted base rates via the sensory link of the plurality of sensors to the real physical world.

3. The digital method for accuracy-enhanced expert forecasting based on an audit-linked best-estimation framework according to claim 2, further comprising:
determining said 90% confidence interval range for the estimated return period based on a market rate and/or an industry rate and/or a market loss ratio value and/or benchmark values of similar transactions or risk-triggered systems.

4. The digital method for accuracy-enhanced expert forecasting based on an audit-linked best-estimation framework according to claim 2, further comprising;
determining said 90% confidence interval range for the estimated return period by setting an upper and lower bound value equal-distant or not-equal-distant to the starting point value of the forecasted value.

5. The digital method for accuracy-enhanced expert forecasting based on an audit-linked best-estimation framework according to claim 2, further comprising:
applying said sensitivity analysis at least by varying a time-based range of an observation window and/or a return period of losses and/or a distribution for fitting and/or different methods for extrapolation.

6. The digital method for accuracy-enhanced expert forecasting based on an audit-linked best-estimation framework according to claim 2, further comprising:
applying said sensitivity analysis additionally by comparing a deviation of the forecasted value over an observation window of 3 years to a yearly forecasted value and/or by comparing the forecasted values by aggregated or separately considered different regions and/or comparing the forecasted values by aggregated or separately considered line of businesses.

7. The digital method for accuracy-enhanced expert forecasting based on an audit-linked best-estimation framework according to claim 2, further comprising:
determining different forecasted values by varying the one or more historical databases for detecting possible biases introduced by specific compositions of the one or more historical databases.

8. The digital method for accuracy-enhanced expert forecasting based on an audit-linked best-estimation framework according to claim 2, wherein the two or more execution members comprise execution members with different role comprising client managers and/or claims experts and/or reserving actuaries and/or casualty R&D members and/or casualty center members and/or faculty underwriting members.

9. A digital method for accuracy-enhanced expert forecasting based on an audit-linked best-estimation framework by applying a controlled decision-making architecture technically supporting human experts to become less biased, wherein a digital platform provides a digital channel for automated audit-based best-estimation forecast of base rate values for underwriting in complex contextual environments covering heterogenous risk sources and risk-exposure classes,
wherein the digital channel being provided with two or more execution members assessing the digital platform using network-enabled devices via a data transmission network, wherein the digital platform at least comprises processing circuitry configured to capture data from a plurality of sensors and the network-enabled devices, the digital method comprising:
executing, by the two or more execution members using the network-enabled devices at least the steps of:
(i) determining a forecasted underwriting base rate value benchmarking the audit-based best-estimation framework to a starting point value based on one or more historical databases,
(ii) determining a 90% confidence interval range for an estimated return period, and
(iii) selecting one or more possible scenarios each having a corresponding probability distribution and applying a sensitivity analysis at least by varying a time-based range of an observation window, wherein if the value of the base rate deviates further from the starting point value as a predefined threshold range by the variation, the starting point value of the base rate is adjusted,
in that a best-estimation base rate value is determined on the forecasted base rate of each execution member, and
wherein the plurality of sensors is coupled to the data processing engine and connected to the digital platform measuring the accuracy the forecasted base rates and providing a digital loop-back process by monitoring and verifying the different forecasted base rates via the sensory link of the plurality of sensors to the real physical world.
